(19) United States
(12) Patent Application Publication
(10) Pub. No.: US 2026/0017036 A1
(43) Pub. Date: Jan. 15, 2026

(54) DATA PAGE GENERATION METHOD AND RELATED DEVICE

(71) Applicant: Beijing Volcano Engine Technology Co., Ltd., Haidian District (CN)

(72) Inventors: Ying Chen, Beijing (CN); Yunpeng Ji, Beijing (CN)

(21) Appl. No.: 19/068,211

(22) Filed: Mar. 3, 2025

(30) Foreign Application Priority Data
Jul. 12, 2024 (CN) 202410939255.8

(51) Int. Cl. G06F 8/38; G06F 8/35; G06T 3/40; G06V 30/412; G06V 30/413

(52) U.S. Cl. CPC G06F 8/38; G06F 8/35; G06T 3/40; G06V 30/412; G06V 30/413

(57) ABSTRACT

The present disclosure provides a data page generation method and a related device. The data page generation method includes: recognizing components and a layout of the components in a user interface picture based on a multimodal large model to obtain a natural language page description corresponding to the user interface picture; converting the natural language page description into domain-specific language codes corresponding to the user interface picture; and performing data page rendering based on the domain-specific language codes to generate a data page corresponding to the user interface picture.

### CROSS-REFERENCE TO RELATED APPLICATION(S)

This application claims priority to Chinese Application No. 202410939255.8 filed on Jul. 12, 2024, the disclosure of which is incorporated herein by reference in its entirety.

### FIELD

The present disclosure relates to a field of computer technologies and, in particular, to a data page generation method and a related device.

### BACKGROUND

A domain-specific language (Domain-Specific Language, DSL) is a computer language specifically designed for a specific domain or a specific task. Compared with a general-purpose programming language (for example, Python, Java, and the like), the DSL focuses on a specific problem domain and provides a more efficient and concise expression.

Some current website building tools allow construction of data pages by means of the DSL. When using these website building tools to construct the data pages, users can build the data pages by means of clicking and dragging according to a user interface (UI) design draft designed by designers. It can be seen that the data pages can be generated by using such website building tools without coding, which can improve the generation efficiency of the data pages to a certain extent.

### SUMMARY

In view of this, an embodiment of the present disclosure provides a data page generation method.

The data page generation method provided by the embodiment of the present disclosure may include: recognizing components and a layout of the components in a user interface picture based on a multimodal large model to obtain a natural language page description corresponding to the user interface picture; converting the natural language page description into domain-specific language codes corresponding to the user interface picture; and performing data page rendering based on the domain-specific language codes to generate a data page corresponding to the user interface picture.

In the embodiment of the present disclosure, before recognizing the components and the layout of the components in the user interface picture based on the multimodal large model, the method further includes: preprocessing the user interface picture.

In the embodiment of the present disclosure, preprocessing the user interface picture includes: scaling the user interface picture and/or enhancing a contrast of the user interface picture.

In the embodiment of the present disclosure, recognizing the components and the layout of the components in the user interface picture based on the multimodal large model includes: pre-constructing a dataset of service component feature description words; generating a prompt by using a preset prompt template and using the dataset of service component feature description words as background knowledge; and inputting the prompt and the user interface picture into the multimodal large model to obtain the natural language page description corresponding to the user interface picture that is output by the multimodal large model.

In the embodiment of the present disclosure, pre-constructing the dataset of service component feature description words includes: selecting a plurality of service components; separately performing feature extraction on each of the plurality of service components to determine an attribute feature of each service component; separately generating a structured description for each service component based on the attribute feature of each service component; and combining the structured descriptions of the respective service components to obtain the dataset of service component feature description words.

In the embodiment of the present disclosure, converting the natural language page description into the domain-specific language codes corresponding to the user interface picture includes: converting the natural language page description into script language codes of the data page based on a large language model; converting the script language codes of the data page into structured data of the data page by means of a script language parser, where the structured data includes node data of a plurality of nodes and relationship data between the plurality of nodes; traversing the plurality of nodes according to the relationship data between the plurality of nodes; and separately converting the node data of the respective nodes from the script language to the domain-specific language in a traversing process, to obtain the domain-specific language codes corresponding to the user interface picture.

In the embodiment of the present disclosure, after converting the natural language page description into the domain-specific language codes corresponding to the user interface picture, the method further includes: correcting the domain-specific language codes based on at least one pre-established correction rule.

Corresponding to the above data page generation method, an embodiment of the present disclosure further provides a data page generation apparatus, including: a component recognition module, configured to recognize components and a layout of the components in a user interface picture based on a multimodal large model to obtain a natural language page description corresponding to the user interface picture; a language conversion module, configured to convert the natural language page description into domain-specific language codes corresponding to the user interface picture; and a rendering module, configured to perform data page rendering based on the domain-specific language codes to generate a data page corresponding to the user interface picture.

In the embodiment of the present disclosure, the data page generation apparatus further includes: a preprocessing module, configured to preprocess the user interface picture.

In the embodiment of the present disclosure, the component recognition module includes: a dataset of service component feature description words, a prompt generator, and a multimodal large model; wherein the prompt generator is configured to generate a prompt by using a preset prompt template and using the dataset of service component feature description words as background knowledge; and the multimodal large model is configured to output the natural language page description corresponding to the user interface picture based on the input prompt and the user interface picture.

In the embodiment of the present disclosure, the language conversion module includes: a large language model, a script language parser, and a script language converter; wherein the large language model is configured to convert the natural language page description into script language codes of a data page; the script language parser is configured to convert the script language codes of the data page into structured data of the data page, wherein the structured data includes node data of a plurality of nodes and relationship data between the plurality of nodes; and the script language converter is configured to traverse the plurality of nodes according to the relationship data between the plurality of nodes, and separately convert the node data of the respective nodes from the script language to the domain-specific language in a traversing process, to obtain the domain-specific language codes corresponding to the user interface picture.

In the embodiment of the present disclosure, the data page generation apparatus further includes: a correction module, configured to correct the domain-specific language codes based on at least one pre-established correction rule.

In addition, an embodiment of the present disclosure further provides an electronic device, including: a memory, a processor, and a computer program stored in the memory and executable by the processor, wherein the processor, when executing the program, implements the above data page generation method.

The embodiment of the present disclosure further provides a non-transitory computer-readable storage medium, wherein the non-transitory computer-readable storage medium stores computer instructions, and the computer instructions are configured to enable the computer to execute the above data page generation method.

The embodiment of the present disclosure further provides a computer program product, including computer program instructions, wherein the computer program instructions, when executed by a computer, enable the computer to execute the above data page generation method.

### BRIEF DESCRIPTION OF THE DRAWINGS

In order to illustrate the technical solutions in the present disclosure or in the related art more clearly, the following will briefly introduce the drawings that need to be used in the description of the embodiments or the related art. Obviously, the drawings in the following description are only some embodiments of the present disclosure, and for those of ordinary skill in the art, other drawings can be obtained according to these drawings without paying any creative effort.

FIG. 1 illustrates an implementation flow of a data page generation method according to some embodiments of the present disclosure.

FIG. 2 illustrates an implementation flow of a specific method for recognizing components and a layout in a user interface picture based on a multimodal large model according to some embodiments of the present disclosure.

FIG. 3 illustrates a schematic diagram of a prompt template according to some embodiments of the present disclosure.

FIG. 4 illustrates an implementation flow of a specific method for converting a natural language page description into DSL codes corresponding to a user interface picture according to some embodiments of the present disclosure.

FIG. 5 illustrates an internal structure of a data page generation apparatus according to some embodiments of the present disclosure.

FIG. 6 illustrates a schematic diagram of a more specific hardware structure of an electronic device according to some embodiments of the present disclosure.

### DETAILED DESCRIPTION OF EMBODIMENTS

In order to make the objectives, technical solutions and advantages of the present disclosure clearer, the present disclosure will be further described in detail below with reference to specific embodiments and the drawings.

It should be noted that, unless otherwise defined, technical terms or scientific terms used in the embodiments of the present disclosure shall have the general meanings as understood by those with ordinary skills in the art to which the present disclosure belongs. The terms “first”, “second”, and the like used in the embodiments of the present disclosure do not represent any order, number, or importance, but are only used to distinguish different components. Similar terms such as “include/comprise”, “including/comprising” and the like mean that the element or object appearing in front of the word covers the element or object and its equivalent listed after the word, without excluding other elements or objects. Similar terms such as “connect” or “connected” are not limited to physical or mechanical connections, but may include electrical connections, whether direct or indirect. “Upper”, “lower”, “left”, “right”, etc. are only used to represent relative positional relationships, and when an absolute position of the described object changes, the relative positional relationship may also change accordingly.

It can be understood that before using the technical solutions of various embodiments in the present disclosure, users will be informed of a type, a usage scope, a usage scenario, etc. of the involved personal information in an appropriate manner, and the users' authorization will be obtained.

For example, in response to receiving an active request from a user, prompt information is sent to the user to clearly prompt the user that the operation requested to be executed will require the acquisition and use of the user's personal information. Thus, the user can independently choose whether to provide personal information to software or hardware, such as an electronic device, an application, a server or a storage medium that performs an operation of a technical solution of the present disclosure, according to the prompt information.

As an optional but not limited implementation, a manner of sending prompt information to the user in response to receiving an active request from the user may be, for example, a pop-up window, and the prompt information may be presented in the pop-up window in a form of text. In addition, the pop-up window may also carry a selection control for the user to select “agree” or “disagree” to provide the personal information to the electronic device.

It can be understood that the above process of notifying and acquiring user authorization is only schematic, and does not constitute a limitation on implementations of the present disclosure. Other manners that meet relevant laws and regulations may also be applied to implementations of the present disclosure.

As described above, in the existing process of constructing a data page by means of the DSL, the user still needs to confirm how to reasonably divide the layout according to the component arrangement in the UI design draft, and meanwhile needs to determine a specific component in the component material library of the website building tools corresponding to the type of components. Usually, the user needs to manually match and adjust component by component, which is cumbersome and time-consuming. Moreover, manual operations are prone to causing an error in component selection or inaccurate layout, which affects the effect of a final page. Meanwhile, frequent communication between the designers of the UI design draft and the user is required to ensure consistent understanding, which further increases time and energy investment. It can be seen that this data page generation manner still has problems such as low efficiency, high error proneness, and high communication costs.

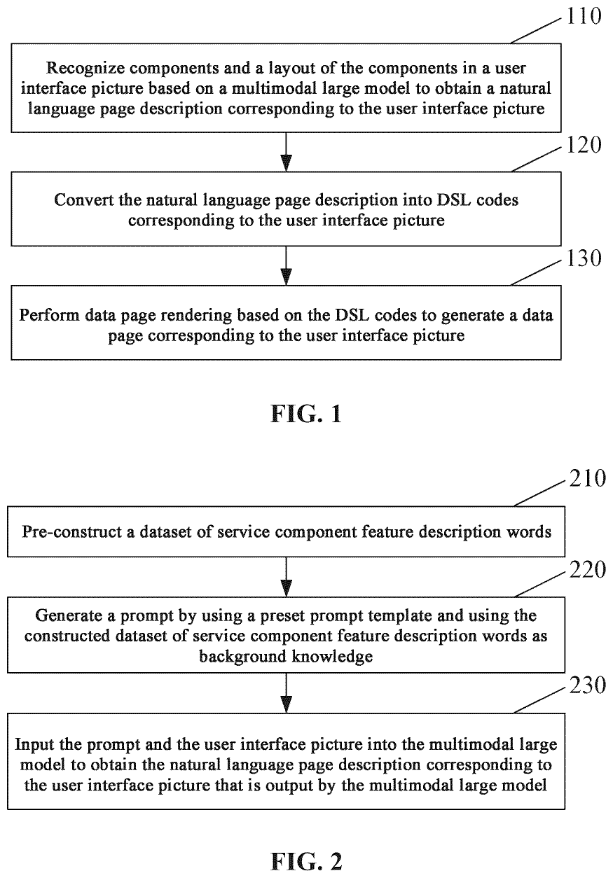

In order to solve the above problems, an embodiment of the present disclosure provides a data page generation method, which can automatically recognize various components and a layout in a UI design draft and automatically generate a data page. FIG. 1 illustrates an implementation flow of the data page generation method provided by the embodiment of the present disclosure. As shown in FIG. 1, the data page generation method provided by the embodiment of the present disclosure mainly includes the following steps.

At step 110, components and a layout of the components in a user interface picture are recognized based on a multimodal large model to obtain a natural language page description corresponding to the user interface picture.

In the embodiment of the present disclosure, the user interface picture may be a screenshot of the UI design draft.

At step 120, the natural language page description is converted into DSL codes corresponding to the user interface picture.

At step 130, data page rendering is performed based on the DSL codes to generate a data page corresponding to the user interface picture.

The specific implementation of each step of the above data page generation method will be described in detail below with reference to specific examples.

In the embodiment of the present disclosure, before recognizing the components and the layout of the components in the user interface picture based on the multimodal large model, the method further includes: preprocessing the user interface picture.

Specifically, in the embodiment of the present disclosure, preprocessing the user interface picture may include: scaling the user interface picture and/or enhancing a contrast of the user interface picture.

The preprocessing of the user interface picture in the embodiment of the present disclosure is, on the one hand, to take into account that the size of an input picture is not fixed, and an excessively large picture may cause the multimodal large model to automatically divide the picture, thereby generating a plurality of picture blocks. These picture blocks may lead to a hallucination phenomenon in a recognition process, thereby causing an error in component recognition. For example, for a picture with only four components, after being divided, the same component may repeatedly appear in a plurality of blocks, thereby causing an error in component recognition. The preprocessing of the user interface picture is, on the other hand, to take into account the clarity of the input picture, and for a blurry input picture, the details of components may also be highlighted by enhancing the contrast, thereby improving the recognition capability of the multimodal large model for the components in the user interface picture.

In the embodiment of the present disclosure, the specific process of scaling the user interface picture may include: firstly, detecting a width and a height of the user interface picture; determining a width scaling ratio and a height scaling ratio respectively based on the width and the height of the user interface picture and a preset width threshold and a preset height threshold in response to determining that the width of the user interface picture exceeds the preset width threshold or the height of the user interface picture exceeds the preset height threshold; then, performing a scaling operation based on the determined width scaling ratio and height scaling ratio; and finally, saving the scaled user interface picture and the scaled width and height.

In the embodiment of the present disclosure, enhancing the contrast of the user interface picture may be implemented by invoking an existing method for enhancing image contrast in image processing.

In the embodiment of the present disclosure, a specific method of recognizing components and a layout in the user interface picture based on the multimodal large model at step 110 may refer to FIG. 2, and includes step 210 to step 230.

At step 210, a dataset of service component feature description words is pre-constructed.

At step 220, a prompt is generated by using a preset prompt template and using the constructed dataset of service component feature description words as background knowledge.

At step 230, the prompt and the user interface picture are input into the multimodal large model to obtain a natural language page description corresponding to the user interface picture that is output by the multimodal large model.

Specifically, in the embodiment of the present disclosure, pre-constructing the dataset of service component feature description words at step 210 may include: selecting a plurality of service components; separately performing feature extraction on each of the plurality of service components to determine an attribute feature of each service component; separately generating a structured description for each service component based on the attribute feature of each service component; and combining the structured descriptions of the respective service components to obtain the dataset of service component feature description words. It should be noted that the step 210 of pre-constructing the dataset of service component feature description words may be completed in advance at one time, and does not need to be repeatedly executed in each process of recognizing components and a layout in the user interface picture using the modal large model.

In the embodiment of the present disclosure, the selected plurality of service components should be able to cover main service requirements and scenarios. For example, the components may include: a text (Text), a title (Title), a button (Button), a reset button (ResetButton), a submit button (SubmitButton), a radio button (Radio), and other components. When performing feature extraction on each selected service component, appearance features, text content features, key attributes, and the like may be summarized, and attribute features related to an application program interface of the service component that can be visually recognized may be determined. Next, a structured description may be generated for each service component based on these attribute features. In the embodiment of the present disclosure, the structured description may have a specific format, for example, a format conforming to a lightweight markup language. Specifically, in practical applications, a Markdown format may be used to generate the structured description of each of the above service components. It should be noted that the step of performing feature extraction on each service component and the step of generating the structured description for each service component may be implemented in various ways such as a general model, a proprietary model, and manual work, and a specific means adopted in the embodiment of the present disclosure is not limited.

The embodiment of the present disclosure systematically summarizes features of service components by collecting and sorting out some component materials of existing website building tools, and deposits them into a dataset of service component description words, thereby establishing a comprehensive and accurate component library to support subsequent automatic recognition and codes conversion processes of component in a data page.

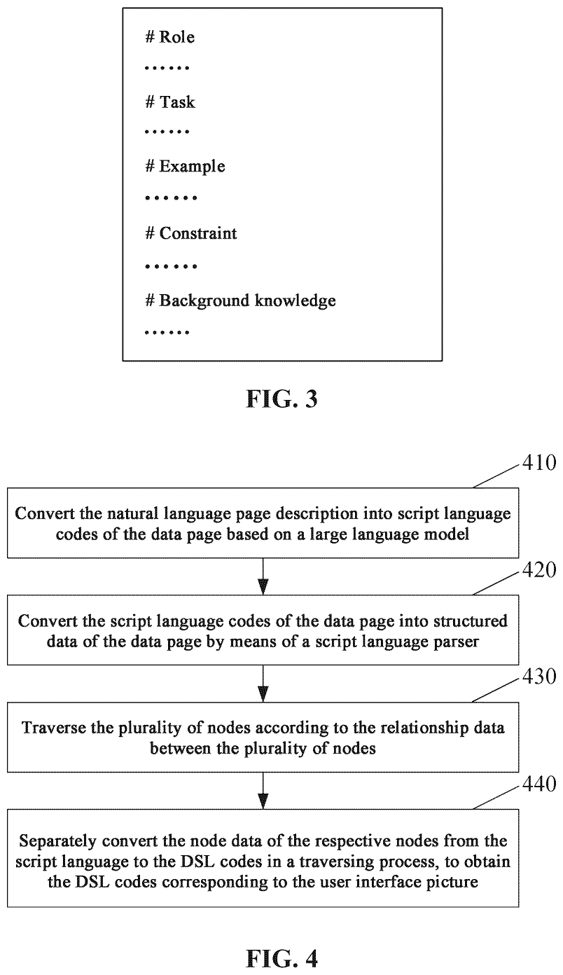

For the above step 220, FIG. 3 illustrates a schematic diagram of a prompt template according to some embodiments of the present disclosure. As shown in FIG. 3, the prompt template may include a plurality of parts such as a role, a task, an example, a constraint, and background knowledge. In the embodiment of the present disclosure, the parts such as the role, the task, the example, and the constraint are preset content. Specifically, the background knowledge part will be filled in the dataset of service component feature description words constructed at the above step 210 to assist the multimodal large model to recognize components more accurately. Specifically, the constraint is used to guide the multimodal large model to better generate the natural language page description according to a specified format. The main function of the prompt is to instruct the multimodal large model to perform a set task as a set role according to the constraint and a constraint reference example of the background knowledge. Specifically, in the embodiment of the present disclosure, an input user interface picture is converted into a corresponding natural language page description.

In addition, in the embodiment of the present disclosure, the multimodal large model may adopt a general multimodal large model, such as a GPT-4 model, etc. The embodiment of the present disclosure fully utilizes the capability of the multimodal large model itself to recognize the components and their layout in the user interface picture, and generate a natural language page description in a specified format.

In the embodiment of the present disclosure, a specific method of converting the natural language page description into the DSL codes corresponding to the user interface picture at step 120 may refer to FIG. 4, and includes step 410 to step 440.

At step 410, the natural language page description is converted into script language codes of a data page based on a large language model.

In the embodiment of the present disclosure, the large language model may be implemented by using a general large language model (LLM). In some other embodiments of the present disclosure, the large language model may also be implemented by using the same model as the multimodal large model. The embodiment of the present disclosure fully utilizes the capability of the large language model or the multimodal large model to convert the natural language page description corresponding to the user interface picture into the script language codes of the data page.

In order to instruct the script language codes output by the large language model to be more accurate, in the above step 410, a constraint may be further set for the large language model. These constraints may include: instructing the large language model to further describe a main axis direction of the data page, contextual information of component layout positions, nesting information of components, and the like.

In the embodiment of the present disclosure, the script language codes may be JSX (Java Script XML) codes. Certainly, the script language codes may also be codes in other formats, which is not limited in the embodiment of the present disclosure.

The script language codes generated through the above step 410 is relatively general, but there is still a certain gap from being available in practical service. In some website building tools, data pages cannot be generated directly using the script language codes, but page restoration is implemented based on a specific set of DSL. The original DSL of the existing website building tools may contain many complex details and data bindings, and for restoration of the UI design draft, such information may be redundant. Therefore, in the embodiment of the present disclosure, firstly, the original DSL of the website building tools is selected and detected, and a more streamlined DSL description is defined. The structure of the above description is similar to a node tree, including a node name and child nodes. The child nodes are represented by an array, wherein elements in the array are in one-to-one correspondence with the order of components in the data page, maintaining a top-down and left-to-right priority order. Next, by summarizing rules of the DSL and converting these rules into an automated program, an automated process of converting the JSX codes into the DSL is realized.

At step 420, the script language codes of the data page is converted into structured data of the data page by means of a script language parser.

In the embodiment of the present disclosure, the structured data may include node data of a plurality of nodes and relationship data between the plurality of nodes. For the JSX codes, in this step, the codes in the JSX string format may be converted into the structured data by means of a JSX parser. In some examples, the above structured data may specifically be an abstract syntax tree (AST).

At step 430, the plurality of nodes are traversed according to the relationship data between the plurality of nodes.

At step 440, the node data of the respective nodes is separately converted from the script language to the DSL codes in the traversing process to obtain the DSL codes corresponding to the user interface picture.

Specifically, in the embodiment of the present disclosure, there is a preset mapping relationship between the node data and the DSL codes, and the node data of the respective nodes is separately converted from the script language to the DSL codes based on the mapping relationship.

In the embodiment of the present disclosure, for the JSX codes, the above plurality of nodes may be traversed and corresponding codes conversion is performed according to the following rules:

1) The outermost layer of the DSL includes two key values: a component name (componentName) and child components (children). A nesting relationship between the components is defined by the children.

2) Each component includes two fields: componentName and children.

The componentName field is a name of the component; the children field lists its child components as an array, and if the current component has no child components, the children may be set to be empty.

3) When the main axis direction is horizontal (flexDirection=row), the <div/> in the JSX codes is converted into a Grid component, and the number of child components in the Grid component is checked: if there are two child components, a “colConfigs” field needs to be added under the “options” field, and the field contains an array of two same objects {“flex”: “ ”, “span”: 12}, where the value of span is calculated as 24/2=12; if there are three child components, there should be three {“flex”: “ ”, “span”: 8}, and the value of span is calculated as 24/3=8.

4) When the main axis direction is vertical (flexDirection=column), the <div/> in the JSX codes is converted into a Div component, and the div without an inline style should also be converted into a Div component.

The above automated program for converting the script language codes into the DSL codes reduces the need for manual intervention, and ensures the consistency and accuracy of the DSL codes, thereby greatly improving the development efficiency and reducing the development cost.

After the DSL codes corresponding to the user interface picture is obtained by the above method, data page rendering may be performed based on the DSL codes at step 130 to generate the data page corresponding to the user interface picture. It should be noted that the embodiment of the present disclosure does not limit the method for performing data page rendering based on the DSL codes.

It can be seen from the above method that the data page generation method provided by the embodiment of the present disclosure can automatically recognize various components and a layout in a UI design draft without coding or manual operations, such as component dragging, by a user, and can automatically generate a data page, which greatly improves the generation efficiency of the data page, and thus can effectively solve the problems of low efficiency, high error proneness, and high communication costs in the existing data page generation manners.

However, the multimodal large model and the large language model are both generative models, and the generated results are not necessarily completely correct, or not necessarily in line with real factual rules. For example, the large model may incorrectly recognize a radio button component as a plurality of button components, and so on.

Therefore, in the embodiment of the present disclosure, after the natural language page description is converted into the DSL codes corresponding to the user interface picture, the method may further include: correcting the DSL codes based on at least one pre-established correction rule.

In the embodiment of the present disclosure, selected components are tested in advance, recognition results of the multimodal large model are summarized, and related rules and requirements are summarized according to historical data page collection. Finally, at least one correction rule is determined, and an automated correction program corresponding to the above correction rule is defined, thereby realizing an automatic optimization process of correcting the DSL codes based on the at least one pre-established correction rule.

Further, in the above specific embodiment, the data page generation method constructs a complete technical link for conversion from a UI design draft to DSL by integrating steps such as image preprocessing, service component recognition, DSL codes generation, and DSL codes correction. This full-link technical innovation not only improves the automation degree of conversion, but also optimizes the generation and application processes of the DSL, which is suitable for a variety of service scenarios and requirements.

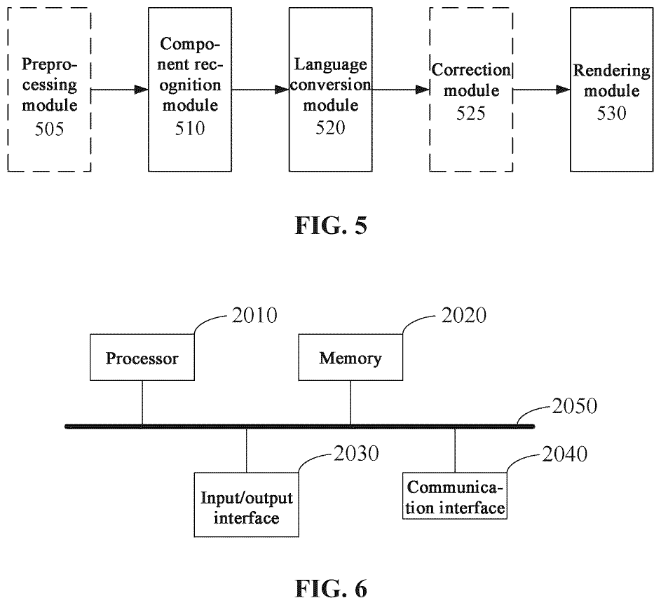

Corresponding to the above data page generation method, an embodiment of the present disclosure further provides a data page generation apparatus, the internal structure of which is shown in FIG. 5, and mainly includes: a component recognition module 510, configured to recognize components and a layout of the components in a user interface picture based on a multimodal large model to obtain a natural language page description corresponding to the user interface picture; a language conversion module 520, configured to convert the natural language page description into DSL codes corresponding to the user interface picture; and a rendering module 530, configured to perform data page rendering based on the DSL codes to generate a data page corresponding to the user interface picture.

In some embodiments of the present disclosure, the data page generation apparatus further includes: a preprocessing module 505, configured to preprocess the user interface picture.

In some embodiments of the present disclosure, the component recognition module 510 may include: a dataset of service component feature description words, a prompt generator, and a multimodal large model.

The prompt generator is configured to generate a prompt by using a preset prompt template and using the dataset of service component feature description words as background knowledge.

The multimodal large model is configured to output a natural language page description corresponding to the user interface picture based on the input prompt and the user interface picture.

In some embodiments of the present disclosure, the language conversion module 520 may include: a large language model, a script language parser, and a script language converter.

The large language model is configured to convert the natural language page description into script language codes of a data page.

The script language parser is configured to convert the script language codes of the data page into structured data of the data page, wherein the structured data includes node data of a plurality of nodes and relationship data between the plurality of nodes.

The script language converter is configured to traverse the plurality of nodes according to the relationship data between the plurality of nodes, and separately convert the node data of the respective nodes from the script language to the domain-specific language in the traversing process to obtain the domain-specific language codes corresponding to the user interface picture.

In some embodiments of the present disclosure, the data page generation apparatus further includes: the method further includes: a correction module 525, configured to correct the DSL codes based on at least one pre-established correction rule.

By means of the above data page generation apparatus, various components and a layout in a UI design draft can be automatically recognized without coding or manual operations, such as component dragging, by a user, and a data page can be automatically generated, which greatly improves the generation efficiency of the data page, and thus can effectively solve the problems of low efficiency, high error proneness, and high communication costs in the existing data page generation manners.

Based on the same inventive concept, corresponding to any of the above embodiments of the method, the present disclosure further provides an electronic device, including: a memory, a processor, and a computer program stored in the memory and executable by the processor, wherein the processor, when executing the program, implements the data page generation method according to any of the above embodiments.

FIG. 6 illustrates a schematic diagram of a more specific hardware structure of an electronic device provided by this embodiment. The device may include a processor 2010, a memory 2020, an input/output interface 2030, a communication interface 2040, and a bus 2050. The processor 2010, the memory 2020, the input/output interface 2030, and the communication interface 2040 are communicatively connected to each other inside the device through the bus 2050.

The processor 2010 may be implemented by using a general-purpose central processing unit (CPU), a microprocessor, an application-specific integrated circuit (ASIC), or one or more integrated circuits, and is configured to execute related programs to implement the technical solutions provided by the embodiments of this specification.

The memory 2020 may be implemented in the form of a read-only memory (ROM), a random access memory (RAM), a static storage device, a dynamic storage device, or the like. The memory 2020 may store an operating system and other applications. When the technical solutions provided by the embodiments of this specification are implemented by using software or firmware, related program codes are stored in the memory 2020 and invoked by the processor 2010 for execution.

The input/output interface 2030 is configured to connect to an input/output device to implement information input and output. The input/output device may be configured in the device as a component, or may be externally connected to the device to provide a corresponding function. The input device may include a microphone, various sensors, and the like, and the output device may include a display, a speaker, a vibrator, an indicator light, and the like.

The communication interface 2040 is configured to connect to a communication module (not shown in the figure) to implement communication interaction between the device and other devices. The communication module may implement communication in a wired manner (for example, a universal serial bus (USB) or a network cable) or a wireless manner (for example, a mobile network, Wi-Fi, or Bluetooth).

The bus 2050 includes a path for transmitting information between various components (such as the processor 2010, the memory 2020, the input/output interface 2030, and the communication interface 2040) of the device.

It should be noted that although the above device only shows the processor 2010, the memory 2020, the input/output interface 2030, the communication interface 2040, and the bus 2050, in the specific implementation process, the device may also include other components necessary for normal operation. In addition, those skilled in the art can understand that the above device may also only include components necessary for implementing the solutions of the embodiments of the present specification, and does not have to include all the components shown in the figure.

The electronic device in the above embodiment is used to implement the corresponding data page generation method in any of the foregoing embodiments, and has the beneficial effects of the corresponding method embodiments, which will not be repeated here.

Based on the same inventive concept, corresponding to any of the above embodiments of the method, the present disclosure further provides a non-transitory computer-readable storage medium, wherein the non-transitory computer-readable storage medium stores computer instructions, and the computer instructions are configured to enable a computer to perform the data page generation method according to any of the above embodiments.

The computer-readable medium in this embodiment includes permanent and non-permanent, removable and non-removable media, and information storage may be implemented by any method or technology. The information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic tape cartridges, magnetic tape magnetic disk storage or other magnetic storage devices or any other non-transmission media, which can be used to store information that can be accessed by a computing device.

The computer instructions stored in the storage medium in the above embodiment are used to cause the computer to perform the task handling method according to any of the above embodiments, and have the beneficial effects of the corresponding method embodiments, which will not be repeated here.

Those of ordinary skill in the art should understand that the discussion of any of the above embodiments is only exemplary, and is not intended to imply that the scope of the present disclosure (including the claims) is limited to these examples. Under the idea of the present disclosure, the technical features in the above embodiments or in different embodiments may also be combined, steps may be implemented in any order, and there are many other variations in different aspects of the embodiments of the present disclosure as described above, which are not provided in detail for the sake of brevity.

In addition, in order to simplify the description and discussion, and to avoid making the embodiments of the present disclosure difficult to understand, the well-known power/ground connections to the integrated circuit (IC) chips and other components may or may not be shown in the drawings provided. In addition, the apparatus may be shown in a block diagram to avoid making the embodiments of the present disclosure difficult to understand, and this also takes into account the fact that the details of the implementations of these block diagram apparatuses are highly dependent on the platform on which the embodiments of the present disclosure are to be implemented (that is, these details should be completely within the understanding of those skilled in the art). In the case where specific details (for example, circuits) are set forth to describe exemplary embodiments of the present disclosure, it is obvious to those skilled in the art that the embodiments of the present disclosure may be implemented without these specific details or with variations of these specific details. Therefore, these descriptions should be considered as illustrative rather than restrictive.

Although the present disclosure has been described in combination with specific embodiments of the present disclosure, many alternatives, modifications, and variations of these embodiments will be obvious to those of ordinary skill in the art according to the previous description. For example, other memory architectures (such as dynamic RAM (DRAM)) may use the discussed embodiments.

The embodiments of the present disclosure are intended to cover all such alternatives, modifications, and variations that fall within the broad scope of the appended claims. Therefore, any omission, modification, equivalent replacement, improvement, etc. made within the spirit and principle of the embodiments of the present disclosure should be included in the protection scope of the present disclosure.

I/We claim:

1. A data page generation method, comprising:
recognizing components and a layout of the components in a user interface picture based on a multimodal large model to obtain a natural language page description corresponding to the user interface picture;
converting the natural language page description into domain-specific language codes corresponding to the user interface picture; and
performing data page rendering based on the domain-specific language codes to generate a data page corresponding to the user interface picture.

2. The method according to claim 1, further comprising: before recognizing the components and the layout of the components in the user interface picture based on the multimodal large model, preprocessing the user interface picture.

3. The method according to claim 2, wherein preprocessing the user interface picture comprises: scaling the user interface picture and/or enhancing a contrast of the user interface picture.

4. The method according to claim 1, wherein recognizing the components and the layout of the components in the user interface picture based on the multimodal large model comprises:
pre-constructing a dataset of service component feature description words;
generating a prompt by using a preset prompt template and using the dataset of service component feature description words as background knowledge; and
inputting the prompt and the user interface picture into the multimodal large model to obtain the natural language page description corresponding to the user interface picture that is output by the multimodal large model.

5. The method according to claim 4, wherein pre-constructing the dataset of service component feature description words comprises:
selecting a plurality of service components;
separately performing feature extraction on each of the plurality of service components to determine an attribute feature of each service component;
separately generating a structured description for each service component based on the attribute feature of each service component; and
combining the structured descriptions of the respective service components to obtain the dataset of service component feature description words.

6. The method according to claim 1, wherein converting the natural language page description into the domain-specific language codes corresponding to the user interface picture comprises:
converting the natural language page description into script language codes of the data page based on a large language model;
converting the script language codes of the data page into structured data of the data page by means of a script language parser, wherein the structured data comprises node data of a plurality of nodes and relationship data between the plurality of nodes;
traversing the plurality of nodes according to the relationship data between the plurality of nodes; and
separately converting the node data of the respective nodes from the script language to the domain-specific language in a traversing process, to obtain the domain-specific language codes corresponding to the user interface picture.

7. The method according to claim 1, further comprising: after converting the natural language page description into the domain-specific language codes corresponding to the user interface picture, correcting the domain-specific language codes based on at least one pre-established correction rule.

8. An electronic device, comprising: a memory, a processor, and a computer program stored in the memory and executable by the processor, wherein the processor, when executing the program, causes the electronic device to:
recognize components and a layout of the components in a user interface picture based on a multimodal large model to obtain a natural language page description corresponding to the user interface picture;
convert the natural language page description into domain-specific language codes corresponding to the user interface picture; and
perform data page rendering based on the domain-specific language codes to generate a data page corresponding to the user interface picture.

9. The electronic device according to claim 8, wherein the processor, when executing the program, further causes the electronic device to: before recognizing the components and the layout of the components in the user interface picture based on the multimodal large model, preprocess the user interface picture.

10. The electronic device according to claim 9, wherein the program causing the electronic device to preprocess the user interface picture causes the processor to: scale the user interface picture and/or enhance a contrast of the user interface picture.

11. The electronic device according to claim 8, wherein the program causing the electronic device to recognize the components and the layout of the components in the user interface picture based on the multimodal large model causes the processor to:
pre-construct a dataset of service component feature description words;
generate a prompt by using a preset prompt template and using the dataset of service component feature description words as background knowledge; and
input the prompt and the user interface picture into the multimodal large model to obtain the natural language page description corresponding to the user interface picture that is output by the multimodal large model.

12. The electronic device according to claim 11, wherein the program causing the electronic device to pre-construct the dataset of service component feature description words causes the processor to:
select a plurality of service components;
separately perform feature extraction on each of the plurality of service components to determine an attribute feature of each service component;
separately generate a structured description for each service component based on the attribute feature of each service component; and
combine the structured descriptions of the respective service components to obtain the dataset of service component feature description words.

13. The electronic device according to claim 8, wherein the program causing the electronic device to convert the natural language page description into the domain-specific language codes corresponding to the user interface picture causes the processor to:
convert the natural language page description into script language codes of the data page based on a large language model;
convert the script language codes of the data page into structured data of the data page by means of a script language parser, wherein the structured data comprises node data of a plurality of nodes and relationship data between the plurality of nodes;
traverse the plurality of nodes according to the relationship data between the plurality of nodes; and
separately convert the node data of the respective nodes from the script language to the domain-specific language in a traversing process, to obtain the domain-specific language codes corresponding to the user interface picture.

14. The electronic device according to claim 8, wherein the processor, when executing the program, further causes the electronic device to: after converting the natural language page description into the domain-specific language codes corresponding to the user interface picture, correct the domain-specific language codes based on at least one pre-established correction rule.

15. A non-transitory computer-readable storage medium storing computer instructions, wherein the computer instructions are configured to cause a computer to:
recognize components and a layout of the components in a user interface picture based on a multimodal large model to obtain a natural language page description corresponding to the user interface picture;
convert the natural language page description into domain-specific language codes corresponding to the user interface picture; and
perform data page rendering based on the domain-specific language codes to generate a data page corresponding to the user interface picture.

16. The non-transitory computer-readable storage medium according to claim 15, wherein the computer instructions further cause the computer to: before recognizing the components and the layout of the components in the user interface picture based on the multimodal large model, preprocess the user interface picture.

17. The non-transitory computer-readable storage medium according to claim 16, wherein the computer instructions causing the computer to preprocess the user interface picture causes the computer to: scale the user interface picture and/or enhance a contrast of the user interface picture.

18. The non-transitory computer-readable storage medium according to claim 15, wherein the computer instructions causing the computer to recognize the components and the layout of the components in the user interface picture based on the multimodal large model causes the computer to:
pre-construct a dataset of service component feature description words;
generate a prompt by using a preset prompt template and using the dataset of service component feature description words as background knowledge; and
input the prompt and the user interface picture into the multimodal large model to obtain the natural language page description corresponding to the user interface picture that is output by the multimodal large model.

19. The non-transitory computer-readable storage medium according to claim 18, wherein the computer instructions causing the computer to pre-construct the dataset of service component feature description words causes the computer to:
select a plurality of service components;
separately perform feature extraction on each of the plurality of service components to determine an attribute feature of each service component;
separately generate a structured description for each service component based on the attribute feature of each service component; and
combine the structured descriptions of the respective service components to obtain the dataset of service component feature description words.

20. The non-transitory computer-readable storage medium according to claim 15, wherein the computer instructions causing the computer to convert the natural language page description into the domain-specific language codes corresponding to the user interface picture causes the computer to:
convert the natural language page description into script language codes of the data page based on a large language model;
convert the script language codes of the data page into structured data of the data page by means of a script language parser, wherein the structured data comprises node data of a plurality of nodes and relationship data between the plurality of nodes;
traverse the plurality of nodes according to the relationship data between the plurality of nodes; and
separately convert the node data of the respective nodes from the script language to the domain-specific language in a traversing process, to obtain the domain-specific language codes corresponding to the user interface picture.
